(19) United States
(12) Patent Application Publication
(10) Pub. No.: US 2021/0042167 A1
(43) Pub. Date: Feb. 11, 2021

(54) Dynamic Package Dependency(ies)

(71) Applicant: Microsoft Technology Licensing, LLC, Redmond, WA (US)

(72) Inventors: Howard Scott KAPUSTEIN, Issaquah, WA (US); Carl Wade RUSSELL, Snoqualmie, WA (US)

(73) Assignee: Microsoft Technology Licensing, LLC, Redmond, WA (US)

(21) Appl. No.: 16/533,871

(22) Filed: Aug. 7, 2019

(51) Int. Cl. G06F 9/52; G06F 16/245

(52) U.S. Cl. CPC G06F 9/52; G06F 16/245

(57) ABSTRACT

Described herein is a system and method for performing dynamic package dependency(ies) in a package identifier-based operating system. A package identifier can store information regarding a dependency target indicating whether the dependency target can be consumed by another package and/or a non-package application. Thus, application(s) developed without package identifier(s) can dynamically access code, libraries, and/or resource(s), etc. associated with one or more other package-based applications. At runtime, process(es) can dynamically add, delete, update and/or expand package dependency(ies), thus extending access to code, library(ies), and/or resource(s) associated with particular trusted/secure package identifier(s).

### BACKGROUND

Computers typically have multiple installed applications, and oftentimes run multiple applications concurrently. These applications typically include executable code, resources such as images and/or text, and so forth. Despite the presence of these various applications, it remains difficult to reliably identify these applications and the resources of the applications. Thus, it remains difficult to perform various operations on computers that rely on the identities of applications and their resources.

### SUMMARY

Described herein is a system for performing dynamic package dependency in a package identifier-based operating system, comprising: a computer comprising a processor and a memory having computer-executable instructions stored thereupon which, when executed by the processor, cause the computer to: receive a request to dynamically add a particular package dependency target to a process; determine whether the particular package dependency target is permitted to be used by the process; and when it is determined that the particular package dependency target is permitted to be used by the process, load the particular package dependency target for the process, wherein the particular dependency target is accessible by the process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for performing dynamic package dependency in a package identifier-based operating system.

FIG. 2 is a functional block diagram that illustrates a dynamic dependency component.

FIG. 3 is a flow chart of a method of performing dynamic package dependency in a package identifier-based operating system.

FIG. 4 is a flow chart of a method of performing dynamic package dependency in a package identifier-based operating system.

FIG. 5 is a flow chart of a method of performing dynamic package dependency in a package identifier-based operating system.

FIG. 6 is a functional block diagram that illustrates an exemplary computing system.

### DETAILED DESCRIPTION

Various technologies pertaining to dynamic package dependency(ies) are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding dynamic package dependency(ies). What follows are one or more exemplary systems and methods.

Aspects of the subject disclosure pertain to the technical problem of dynamic package dependency(ies). The technical features associated with addressing this problem involve receiving a request to dynamically add a particular package dependency target to a process; determining whether the particular package dependency target is permitted to be used by the process; and when it is determined that the particular package dependency target is permitted to be used by the process, loading the particular package dependency target for the process, wherein the particular package dependency target is accessible by the process. Accordingly, aspects of these technical features exhibit technical effects of more efficiently and effectively allowing application(s) to dynamically add and/or delete package dependency target(s), for example, reducing computer resource consumption.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

In a package identifier-based operating system, an application and/or other code, libraries, resources, and so forth is distributed as part of a package. A package has an associated package identifier that is based on one or more elements, such as a name of the package, a publisher of the package, an architecture of the package, a resource type of the package, and/or a version of the package. When the application is installed on a device, the package identifier is maintained in a protected manner so that the package identifier is accessible to the operating system of the device but not to other applications running on the device. When running an application installed from the package, one or more processes are created each of which is assigned a security identifier based on the package identifier. This security identifier can be used in a variety of different manners, such as to permit access to a storage area dedicated to applications installed from the package, to permit communication with other processes, and so forth.

A package identifier thus provides a trustable identity for an application which is defined at install-time. Conventionally, once the application and associated package identifier(s) were installed, a chain of dependency(ies) was computed, stored, and unchangeable. Thus, package identifiers provided a static model for securely identifying running process(es).

Described herein is a system and method for performing dynamic package dependency(ies) in a package identifier-based operating system. For example, application(s) developed without package identifier(s) can dynamically access code, libraries, and/or resource(s), etc. associated with one or more other package-based applications. At runtime, process(es) can dynamically add, delete, update and/or expand package dependency(ies), thus extending access to code, library(ies), and/or resource(s) associated with particular trusted/secure package identifier(s).

In some embodiments, the process(es) requesting package dependency(ies) do not having associated package identifier(s) (e.g., non package-based application(s)). In some embodiments, the process(es) requesting package dependency(ies) have package identifier(s); however, the process(es) dynamically request access to code, library(ies), and/or resource(s) associated with other package-based application(s).

A conventional package-identifier based application model provides a static view of installed packages as only package dependencies based on what was defined at install-time were supported. The system and method described herein enable package dependency(ies) to be altered at run-time.

In some embodiments, the system and method described herein can enable application plugins to work with in conjunction with application package(s). In some embodiments, the system and method described herein can enable non packaged application(s), which generally do not have static dependencies, to, at runtime, dynamically gain access to packaged resource(s) in a safe, secure, and reliable way (e.g., without having to write a manifest and creating packaging)

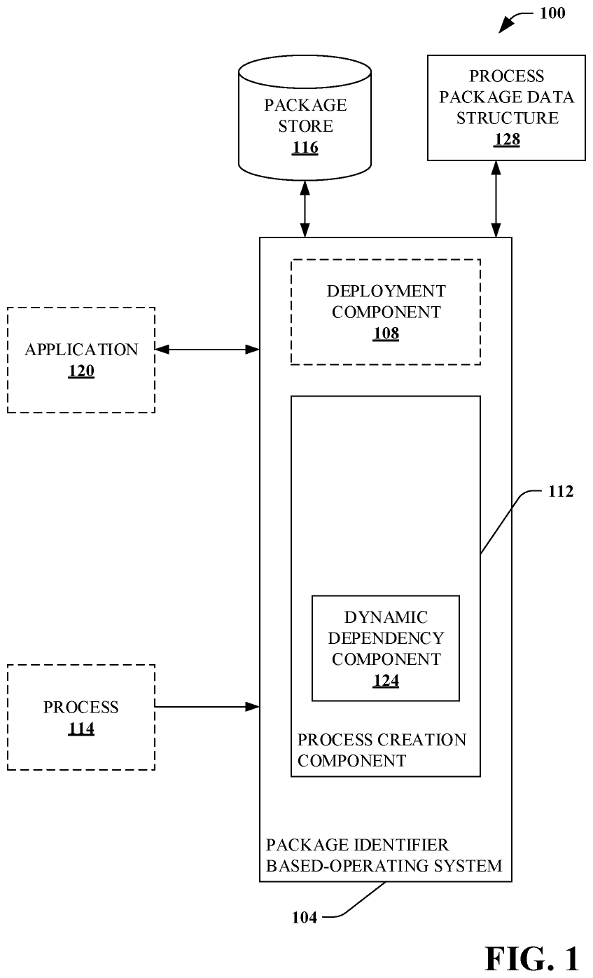

Referring to FIG. 1, a system for performing dynamic package dependency in a package identifier-based operating system 100 is illustrated. The system 100 includes a package identifier-based operating system 104 that installs applications in packages on the system 100 and manages running of those applications on the system 100.

### Deployment

An application is included in a package for deployment, and a package includes one or more components or modules for one or more applications. These components or modules can include binary code that is executed as part of an application or code that is interpreted or otherwise processed as part of an application, text or images that are part of (resources of) the application or other data that is part of the application, a library that is part of or used by the application and so forth.

The package identifier-based operating system 104 can include a deployment component 108 that manages installation of one or more applications, based on package(s). The package identifier-based operating system 104 can include a process creation component 112 that manages the creation of process(es) 114 based on installed applications.

A package can include one or more files, which can include various components or modules for one or more applications. A package can also include a manifest that includes various metadata indicating actions to be taken to install package. The manifest can be associated with a package and identifies how to install the package, such as which files are to be written to disk, what configuration values are to be set (e.g., in an operating system registry or store), and so forth.

The manifest can include a package identifier, which can include various elements, for example, a name, a publisher, an architecture, a resource type, and/or a version. For example, the name can be a name assigned to package by the developer of package. Publisher is a name of the publisher of package, which is typically the developer or distributor of package. The publisher can identify various entities such as a corporation, an individual, etc. Architecture refers to the processor and/or device architecture with which the components or modules of package are designed to operate. The developer can choose one or more architecture identifiers to include as architecture. Various different processor and/or device architectures can be identified, such as an ×86 architecture, an ×64 architecture, a RISC (reduced instruction set computer architecture), and so forth. Version is a version identifier of package 302. For example, the developer can choose any versioning indications (e.g., numeric sequences, alphanumeric sequences, etc.) that the developer desires.

Resource type can be any of a variety of different values or attributes identifying characteristics of package. For example, the developer can choose any characteristics that the developer desires. These characteristics can include, for example, the country or geographic region in which the components or modules of package are designed to operate, the language (e.g., English, French, Japanese, etc.) that the components or modules of package use, a form factor (e.g., desktop/laptop, tablet/slate, etc.) for which the components or modules of package are designed to operate, one or more screen resolutions for which the components or modules of package are designed to operate, whether the package includes trial versions or fully licensed versions of applications, and so forth. The package identifier can further include information regarding dependency target indicating whether the dependency target (e.g., package contents) can be consumed by other package(s) and/or non-package(s).

A package certificate can also be associated with the package. The package certificate can include an identifier of the publisher of package, which can be verified as being the same as the publisher identified in the package identifier when installing package.

One or more applications included in a package are installed by the deployment component 108. As part of the installation or deployment, deployment component 108 verifies that the publisher identified in the package certificate associated with package (e.g., package certificate) has not been altered or tampered with.

If the publisher identified in the package certificate associated with package has not been altered or tampered with, then deployment component 108 verifies that the publisher identified in the package certificate associated with package is the same as the publisher in the package identifier of the package. The deployment component 108 then installs the one or more applications in the package if the publisher identified in the package certificate associated with package is the same as the publisher in package identifier. If the publisher identified in the package certificate associated with package is not the same as the publisher in package identifier, then deployment module does not install the one or more applications in package.

The deployment component 108 also maintains a package store 116, in which the deployment component 108 stores various information regarding installed packages, including an identification of each installed package (e.g., the package identifier of the package) and the manifests associated with the installed packages. The deployment component 108 can record, during installation or deployment of the one or more applications in the package, a record of package identifier in the package store 116. The package identifier in store 116 is maintained or otherwise indicated as being associated with the one or more applications installed from the package. The package identifiers in package store 116 are maintained in a protected manner, allowing the package identifiers to be accessed by operating system 104 but not by other running processes. Thus, a process created from an application installed from a package would not have access to the package identifier stored in package store 116. The package identifiers can be protected in a variety of different manners, such as maintaining package store 116 in a location of memory that is only accessible to operating system 104, storing package identifiers in a data structure that is encrypted using a key known only to operating system 104, and so forth.

### Run-time

When an application 120 begins running, process creation component 112 manages the creation of one or more processes 114 for that application 120. For package-based application(s) utilizing static dependency(ies), if any, process creation component 112 can assign the package identifier associated with that application 120 to the one or more processes 114. The process creation component 112 can store information regarding package dependencies in a process package data store 128. In some embodiments, the process package data store 128 comprises an in-memory linked-list which can be modified at run-time. In some embodiments, the process package data store 128 includes package dependency(ies) encompassing initial (static) packages and, dynamic package(s).

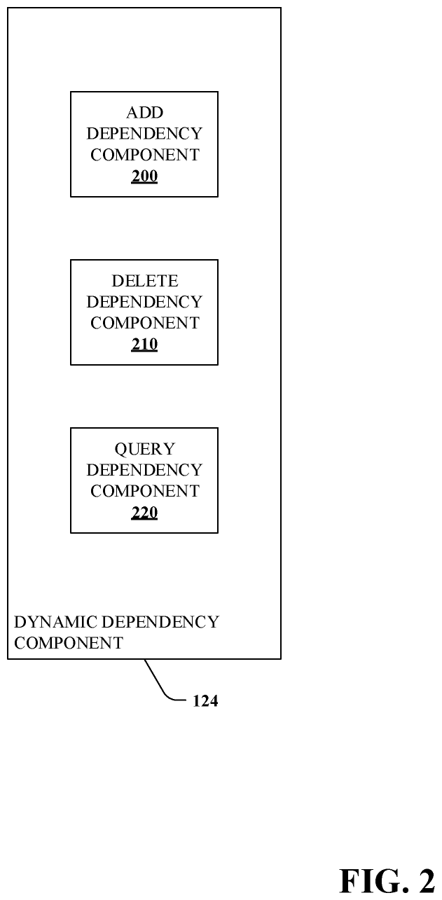

Referring to FIG. 2 with continued reference to FIG. 1, a dynamic dependency component 124 of the process creation component 112 can include an add dependency component 200 (e.g., application programming interface (API)), a delete dependency component 210 (e.g., API), and/or a query dependency component 220 (e.g., API).

For non-package based application(s) and/or runtime request(s) from package-based application(s), the dynamic dependency component 124 of the process creation component 112 can utilize information stored in the package store 116 to determine whether or not the process 114 for the application 120 is permitted to use a requested particular package dependency target.

The dynamic dependency component 124 can receive a request to dynamically add a particular package dependency target to a process 114 (e.g., via the add dependency component 200 (e.g., application programming interface (API)). The dynamic dependency component 124 can then determine whether the particular package dependency target is permitted to be used by the process 114 based, at least in part, upon information stored in the package storage 116. For example, as noted above, the package identifier associated with the particular package can include a dependency target that can store information regarding whether the package contents can be consumed by other package(s) and/or non-package(s). In some embodiments, the dependency target can be one or more a library(ies) and/or resource(s). In some embodiments, the dependency target can be a hierarchical structure (e.g., a tree) comprising a plurality of hierarchically organized library(ies) and/or resource(s) of a same package and/or different packages.

When it is determined that the particular package dependency target is permitted to be used by the process 114, the particular package dependency target can be loaded (e.g., by a loader of the operating system 104). The particular package dependency target can then be accessible by the process 114 as created by the process creation component 112. The process creation component 112 can store information regarding package dependencies in the process package data store 128 (e.g., in-memory linked-list).

For non-package based application(s) and/or runtime request(s) from package-based application(s), an executing process 114 can request deletion of a particular target dependency from its process space. In response to the deletion request, the delete dependency component 210 of the dynamic dependency component 124 can remove/delete information regarding the particular target dependency of the executing process 114 from the process package data store 128.

Using the query dependency component 220, the operating system 104, the deployment component 108, and/or the process 114 can query the process package data store 128 to determine whether or not a particular package can be safely serviced, that is, whether any process(es) 114 are currently utilizing the particular package.

As discussed above, package identifiers can include a version identifier (“generation id”). In some embodiments, component(s) of the operating system 104 and/or application(s) can query the process package data structure 128 via the query dependency component 220 to detect if dependency(ies) have changed. For example, in response to determining that a different version of a package is currently being utilized, a subcomponent of the operating system 104 can be updated to use the different version.

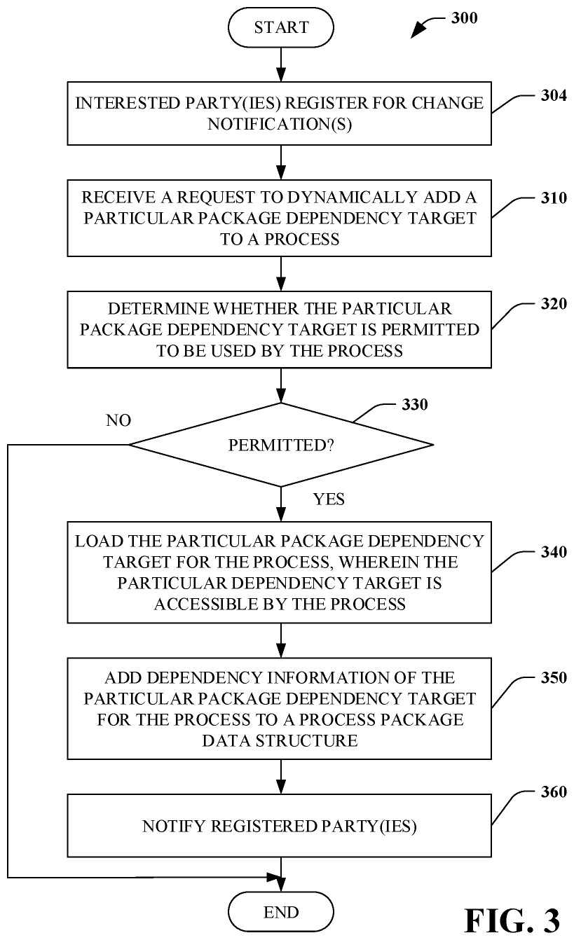

FIGS. 3-5 illustrate exemplary methodologies relating to dynamic package dependency(ies). While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 3, a method of performing dynamic package dependency in a package identifier-based operating system 300 is illustrated. In some embodiments, the method 300 is performed by the system 100.

At 304, optionally, interested party(ies) register for change notification(s). At 310, a request to dynamically add a particular package dependency target to a process is received. At 320, a determination is made as to whether the particular package dependency target is permitted to be used by the process. At 330, when it is determined that the particular package dependency target is not permitted to be used by the process, no further process occurs. At 330, when it is determined that the particular package dependency target is permitted to be used by the process, at 340, the particular package dependency target is loaded for the process. The particular package dependency target is accessible by the process. At 350, dependency information of the particular package dependency target for the process is added to a process package data structure, and, no further processing occurs. At 360, registered party(ies), if any, are notified of the removal of the particular package dependency target.

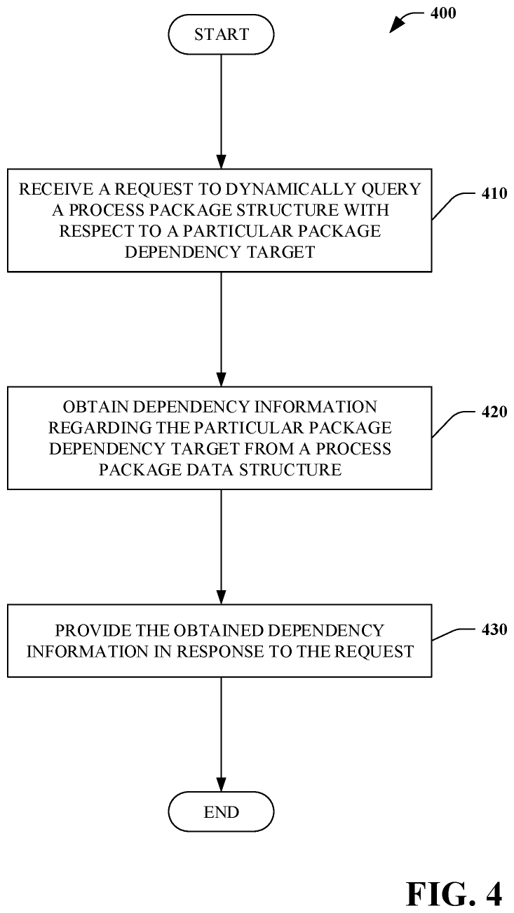

Turning to FIG. 4, a method of performing dynamic package dependency in a package identifier-based operating system 400 is illustrated. In some embodiments, the method 400 is performed by the system 100.

At 410, a request to dynamically query a process package data structure with respect to a particular package dependency target is received (e.g., at runtime of the process). At 420, dependency information regarding the particular package dependency target is obtained from a process data structure. At 430, the obtained dependency information is provided in response to the request.

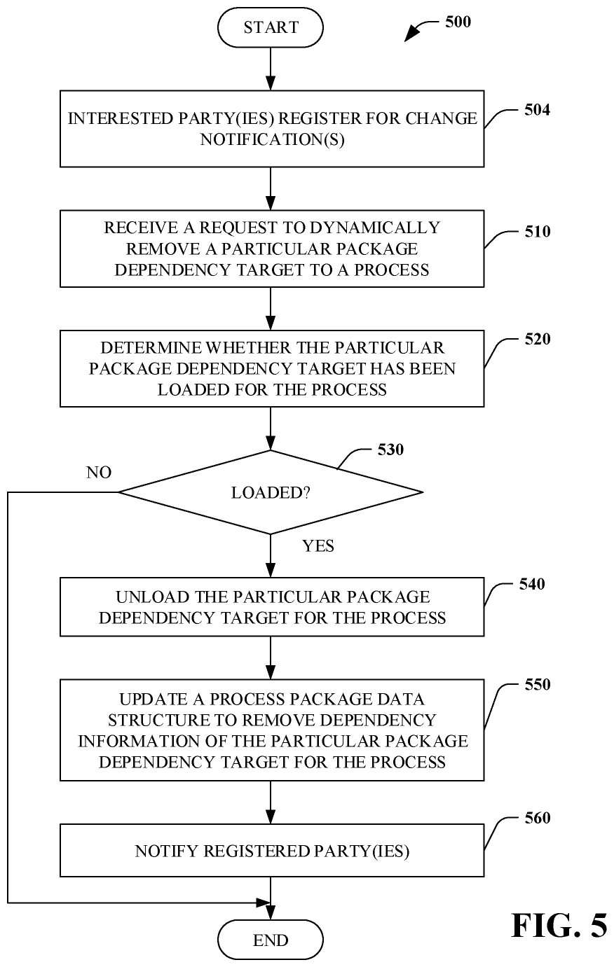

Referring to FIG. 5, a method of performing dynamic package dependency in a package identifier-based operating system 500 is illustrated. In some embodiments, the method 500 is performed by the system 100.

At 504, optionally, interested party(ies) register for change notification(s). At 510, a request to dynamically remove a particular package dependency target from a process is received. At 520, a determination is made as to whether the particular package dependency target has been loaded for the process. At 530, if it is determined that the particular package dependency target has not been loaded for the process, no further processing occurs. When it is determined that the particular package dependency target has been loaded for the process, at 540, the particular package dependency target is unloaded from the process. At 550, a process data structure is updated to remove the particular package dependency target from the process, and, no further process occurs. At 560, registered party(ies), if any, are notified of the removal of the particular package dependency target.

Described herein is a system for performing dynamic package dependency in a package identifier-based operating system, comprising: a computer comprising a processor and a memory having computer-executable instructions stored thereupon which, when executed by the processor, cause the computer to: receive a request to dynamically add a particular package dependency target to a process; determine whether the particular package dependency target is permitted to be used by the process; and when it is determined that the particular package dependency target is permitted to be used by the process, load the particular package dependency target for the process, wherein the particular dependency target is accessible by the process.

The system can further include wherein the particular package dependency target is identified by a package identifier. The system can further include wherein the package identifier comprises information regarding a dependency target indicating whether the dependency target can be consumed by at least one of another package or a non-package application.

The system can include the memory having further computer-executable instructions stored thereupon which, when executed by the processor, cause the computer to: when it is determined that the particular package dependency target is permitted to be used by the process, add dependency information for the particular package dependency target and the process to a package process data structure.

The system can further include wherein the package process data structure is a linked-list storing information regarding loaded packages and package dependencies. The system can include the memory having further computer-executable instructions stored thereupon which, when executed by the processor, cause the computer to: receive a request to dynamically query the process package data structure with respect to another particular package dependency target; obtain dependency information regarding the another particular package dependency target from the process data structure; and in response to the request to dynamically query, provide the obtained dependency information.

The system can include the memory having further computer-executable instructions stored thereupon which, when executed by the processor, cause the computer to: receive a request to dynamically remove the particular package dependency target from the process; determine whether the particular package dependency target has been loaded for the process; when it is determined that the particular package dependency target has been loaded for the process: unload the particular package dependency target from the process; and update the process data structure to remove the particular package dependency target from the process.

Described herein is a method for performing dynamic package dependency in a package identifier-based operating system, comprising: receiving a request to dynamically add a particular package dependency target to a process; determining whether the particular package dependency target is permitted to be used by the process; and when it is determined that the particular package dependency target is permitted to be used by the process, loading the particular package dependency target for the process, wherein the particular package dependency target is accessible by the process.

The method can further include wherein the particular package dependency target is identified by a package identifier. The method can further include wherein the package identifier comprises information regarding a dependency target indicating whether the dependency target can be consumed by at least one of another package or a non-package application.

The method can further include when it is determined that the particular package dependency target is permitted to be used by the process, adding dependency information for the particular package dependency target and the process to a package process data structure.

The method can further include wherein the package process data structure is a linked-list storing information regarding loaded packages and package dependencies. The method can further include receiving a request to dynamically query the process package data structure with respect to another particular package dependency target; obtaining dependency information regarding the another particular package dependency target from the process data structure; and in response to the request to dynamically query, providing the obtained dependency information.

The method can further include: receiving a request to dynamically remove the particular package dependency target from the process; determining whether the particular package dependency target has been loaded for the process; when it is determined that the particular package dependency target has been loaded for the process: unloading the particular package dependency target from the process; and updating the process data structure to remove the particular package dependency target from the process.

Described herein is a computer storage media storing computer-readable instructions that when executed cause a computing device to: receive a request to dynamically add a particular package dependency target to a process; determine whether the particular package dependency target is permitted to be used by the process; and when it is determined that the particular package dependency target is permitted to be used by the process, load the particular package dependency target for the process, wherein the particular package dependency target is accessible by the process.

The computer storage media can further include wherein the particular package dependency target is identified by a package identifier, wherein the package identifier comprises information regarding a dependency target indicating whether the dependency target can be consumed by at least one of another package or a non-package application.

The computer storage media can store further computer-readable instructions that when executed cause a computing device to: when it is determined that the particular package dependency target is permitted to be used by the process, add dependency information for the particular package dependency target and the process to a package process data structure. The computer storage media can further include wherein the package process data structure is a linked-list storing information regarding loaded packages and package dependencies.

The computer storage media can store further computer-readable instructions that when executed cause a computing device to: receive a request to dynamically query the process package data structure with respect to another particular package dependency target; obtain dependency information regarding the another particular package dependency target from the process data structure; and in response to the request to dynamically query, provide the obtained dependency information.

The computer storage media can store further computer-readable instructions that when executed cause a computing device to: receive a request to dynamically remove the particular package dependency target from the process; determine whether the particular package dependency target has been loaded for the process; when it is determined that the particular package dependency target has been loaded for the process: unload the particular package dependency target from the process; and update the process data structure to remove the particular package dependency target from the process.

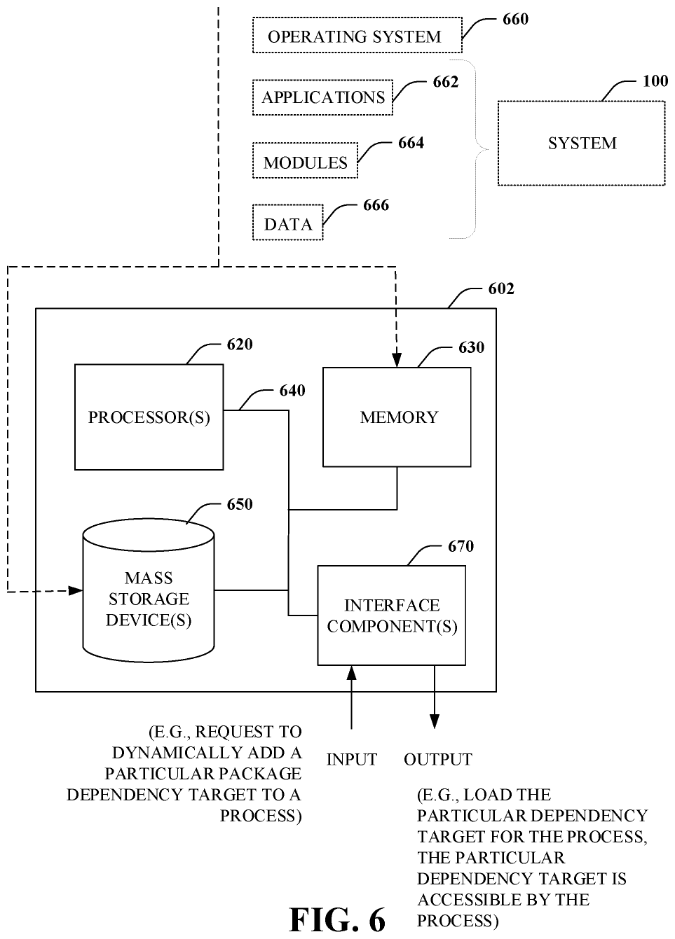

With reference to FIG. 6, illustrated is an example general-purpose computer or computing device 602 (e.g., mobile phone, desktop, laptop, tablet, watch, server, hand-held, programmable consumer or industrial electronics, set-top box, game system, compute node). For instance, the computing device 602 may be used in a system for performing dynamic package dependency in a package identifier-based operating system 100.

The computer 602 includes one or more processor(s) 620, memory 630, system bus 640, mass storage device(s) 650, and one or more interface components 670. The system bus 640 communicatively couples at least the above system constituents. However, it is to be appreciated that in its simplest form the computer 602 can include one or more processors 620 coupled to memory 630 that execute various computer executable actions, instructions, and or components stored in memory 630. The instructions may be, for instance, instructions for implementing functionality described as being carried out by one or more components discussed above or instructions for implementing one or more of the methods described above.

The processor(s) 620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 620 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 620 can be a graphics processor.

The computer 602 can include or otherwise interact with a variety of computer-readable media to facilitate control of the computer 602 to implement one or more aspects of the claimed subject matter. The computer-readable media can be any available media that can be accessed by the computer 602 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM)), magnetic storage devices (e.g., hard disk, floppy disk, cassettes, tape), optical disks (e.g., compact disk (CD), digital versatile disk (DVD)), and solid state devices (e.g., solid state drive (SSD), flash memory drive (e.g., card, stick, key drive)), or any other like mediums that store, as opposed to transmit or communicate, the desired information accessible by the computer 602. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 630 and mass storage device(s) 650 are examples of computer-readable storage media. Depending on the exact configuration and type of computing device, memory 630 may be volatile (e.g., RAM), non-volatile (e.g., ROM, flash memory) or some combination of the two. By way of example, the basic input/output system (BIOS), including basic routines to transfer information between elements within the computer 602, such as during start-up, can be stored in nonvolatile memory, while volatile memory can act as external cache memory to facilitate processing by the processor(s) 620, among other things.

Mass storage device(s) 650 includes removable/non-removable, volatile/non-volatile computer storage media for storage of large amounts of data relative to the memory 630. For example, mass storage device(s) 650 includes, but is not limited to, one or more devices such as a magnetic or optical disk drive, floppy disk drive, flash memory, solid-state drive, or memory stick.

Memory 630 and mass storage device(s) 650 can include, or have stored therein, operating system 660, one or more applications 662, one or more program modules 664, and data 666. The operating system 660 acts to control and allocate resources of the computer 602. Applications 662 include one or both of system and application software and can exploit management of resources by the operating system 660 through program modules 664 and data 666 stored in memory 630 and/or mass storage device (s) 650 to perform one or more actions. Accordingly, applications 662 can turn a general-purpose computer 602 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 662, and include one or more modules 664 and data 666 stored in memory and/or mass storage device(s) 650 whose functionality can be realized when executed by one or more processor(s) 620.

In some embodiments, the processor(s) 620 can correspond to a system on a chip (SOC) or like architecture including, or in other words integrating, both hardware and software on a single integrated circuit substrate. Here, the processor(s) 620 can include one or more processors as well as memory at least similar to processor(s) 620 and memory 630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 602 also includes one or more interface components 670 that are communicatively coupled to the system bus 640 and facilitate interaction with the computer 602. By way of example, the interface component 670 can be a port (e.g., serial, parallel, PCMCIA, USB, FireWire) or an interface card (e.g., sound, video, etc.) or the like. In one example implementation, the interface component 670 can be embodied as a user input/output interface to enable a user to enter commands and information into the computer 602, for instance by way of one or more gestures or voice input, through one or more input devices (e.g., pointing device such as a mouse, trackball, stylus, touch pad, keyboard, microphone, joystick, game pad, satellite dish, scanner, camera, other computer). In another example implementation, the interface component 670 can be embodied as an output peripheral interface to supply output to displays (e.g., LCD, LED, plasma), speakers, printers, and/or other computers, among other things. Still further yet, the interface component 670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for performing dynamic package dependency in a package identifier-based operating system, comprising:
a computer comprising a processor and a memory having computer-executable instructions stored thereupon which, when executed by the processor, cause the computer to:
receive a request to dynamically add a particular package dependency target to a process;
determine whether the particular package dependency target is permitted to be used by the process; and
when it is determined that the particular package dependency target is permitted to be used by the process, load the particular package dependency target for the process, wherein the particular dependency target is accessible by the process.

2. The system of claim 1, wherein the particular package dependency target is identified by a package identifier.

3. The system of claim 2, wherein the package identifier comprises information regarding a dependency target indicating whether the dependency target can be consumed by at least one of another package or a non-package application.

4. The system of claim 1, the memory having further computer-executable instructions stored thereupon which, when executed by the processor, cause the computer to:
when it is determined that the particular package dependency target is permitted to be used by the process, add dependency information for the particular package dependency target and the process to a package process data structure.

5. The system of claim 4, wherein the package process data structure is a linked-list storing information regarding loaded packages and package dependencies.

6. The system of claim 4, the memory having further computer-executable instructions stored thereupon which, when executed by the processor, cause the computer to:
receive a request to dynamically query the process package data structure with respect to another particular package dependency target;
obtain dependency information regarding the another particular package dependency target from the process data structure; and
in response to the request to dynamically query, provide the obtained dependency information.

7. The system of claim 4, the memory having further computer-executable instructions stored thereupon which, when executed by the processor, cause the computer to:
receive a request to dynamically remove the particular package dependency target from the process;
determine whether the particular package dependency target has been loaded for the process;
when it is determined that the particular package dependency target has been loaded for the process:
unload the particular package dependency target from the process; and
update the process data structure to remove the particular package dependency target from the process.

8. A method for performing dynamic package dependency in a package identifier-based operating system, comprising:
receiving a request to dynamically add a particular package dependency target to a process;
determining whether the particular package dependency target is permitted to be used by the process; and
when it is determined that the particular package dependency target is permitted to be used by the process, loading the particular package dependency target for the process, wherein the particular package dependency target is accessible by the process.

9. The method of claim 8, wherein the particular package dependency target is identified by a package identifier.

10. The method of claim 9, wherein the package identifier comprises information regarding a dependency target indicating whether the dependency target can be consumed by at least one of another package or a non-package application.

11. The method of claim 8, further comprising:
when it is determined that the particular package dependency target is permitted to be used by the process, adding dependency information for the particular package dependency target and the process to a package process data structure.

12. The method of claim 11, wherein the package process data structure is a linked-list storing information regarding loaded packages and package dependencies.

13. The method of claim 11, further comprising:
receiving a request to dynamically query the process package data structure with respect to another particular package dependency target;
obtaining dependency information regarding the another particular package dependency target from the process data structure; and
in response to the request to dynamically query, providing the obtained dependency information.

14. The method of claim 11, further comprising:
receiving a request to dynamically remove the particular package dependency target from the process;
determining whether the particular package dependency target has been loaded for the process;
when it is determined that the particular package dependency target has been loaded for the process:
unloading the particular package dependency target from the process; and
updating the process data structure to remove the particular package dependency target from the process.

15. A computer storage media storing computer-readable instructions that when executed cause a computing device to:
receive a request to dynamically add a particular package dependency target to a process;
determine whether the particular package dependency target is permitted to be used by the process; and
when it is determined that the particular package dependency target is permitted to be used by the process, load the particular package dependency target for the process, wherein the particular package dependency target is accessible by the process.

16. The computer storage media of claim 15, wherein the particular package dependency target is identified by a package identifier, wherein the package identifier comprises information regarding a dependency target indicating whether the dependency target can be consumed by at least one of another package or a non-package application.

17. The computer storage media of claim 15, storing further computer-readable instructions that when executed cause a computing device to:
when it is determined that the particular package dependency target is permitted to be used by the process, add dependency information for the particular package dependency target and the process to a package process data structure.

18. The computer storage media of claim 17, wherein the package process data structure is a linked-list storing information regarding loaded packages and package dependencies.

19. The computer storage media of claim 17, storing further computer-readable instructions that when executed cause a computing device to:
receive a request to dynamically query the process package data structure with respect to another particular package dependency target;
obtain dependency information regarding the another particular package dependency target from the process data structure; and
in response to the request to dynamically query, provide the obtained dependency information.

20. The computer storage media of claim 17, storing further computer-readable instructions that when executed cause a computing device to:
receive a request to dynamically remove the particular package dependency target from the process;
determine whether the particular package dependency target has been loaded for the process;
when it is determined that the particular package dependency target has been loaded for the process:
unload the particular package dependency target from the process; and
update the process data structure to remove the particular package dependency target from the process.
